(19) United States
(12) Patent Application Publication
(10) Pub. No.: US 2008/0055147 A1
(43) Pub. Date: Mar. 6, 2008

(54) Method and apparatus for controlling an existing remote control

(76) Inventor: Tuan Le Van, Ville Mont-Royal (CA)

Correspondence Address: OGILVY RENAULT LLP, 1981 MCGILL COLLEGE AVENUE, SUITE 1600, MONTREAL, QC, H3A2Y3, US

(21) Appl. No.: 11/896,033

(22) Filed: Aug. 29, 2007

Related U.S. Application Data
(60) Provisional application No. 60/840,703, filed on Aug. 29, 2006.

(51) Int. Cl. H04L 17/02

(52) U.S. Cl. 341/176

(57) ABSTRACT

There is described a device for controlling a primary remote control, the apparatus comprising: a receiver adapted to receive a control signal for remotely operating an apparatus from a secondary remote control; and control circuitry coupled to the receiver, configured to be operatively connected to the primary remote control and adapted to communicate the control signal to the primary remote control, thereby activating the primary remote control for operation of the apparatus.

### CROSS-REFERENCE TO RELATED APPLICATIONS

This application claims priority of U.S. Provisional Patent Application bearing Ser. No. 60/840,703, filed on Aug. 29, 2006, the contents of which are hereby incorporated by reference.

### TECHNICAL FIELD

This invention pertains to the field of telecommunications, and more specifically, the field of remote control devices.

### BACKGROUND OF THE INVENTION

Until recently, vehicles sold by car manufacturers, such as GM or Chrysler, did not include a remote car starter. Those who were interested in having a remote car starter had to bring their vehicle to a specialized merchant to have the equipment installed in the vehicle post-purchase.

Eventually, car manufacturers began integrating these devices into all manufactured vehicles directly. If a buyer selected a remote car starter as an option, then the device would be activated. If the buyer did not select (i.e. pay for) the option of having a remote car starter, the device was simply left non-activated, even though it was already present.

The technology used to make effective and robust remote car starters is complex and costly. Car manufacturers are reluctant to invest in developing and exploiting such technology, especially since their practice includes integrating the device in all manufactured vehicles regardless of whether the option will be paid for or not.

Therefore, the remote control devices integrated into newly-purchased vehicles use less advanced technology than those bought from specialized merchants.

### SUMMARY OF THE INVENTION

In accordance with a first broad aspect of the present invention, there is provided a system for controlling a primary remote control device, the system comprising: a secondary remote control device having a transmitter and configured to transmit a control signal for remotely operating an apparatus; a receiver adapted to receive the control signal; an antenna for coupling the transmitter and the receiver; and control circuitry coupled to the receiver and configured to be operatively connected to the primary remote control device, the control circuitry adapted to communicate the control signal to the primary remote control device, thereby activating the primary remote control device for operation of the apparatus.

In accordance with a second broad aspect of the present invention, there is provided a device for controlling a primary remote control device, the apparatus comprising: a receiver adapted to receive a control signal for remotely operating an apparatus from a secondary remote control device; and control circuitry coupled to the receiver, configured to be operatively connected to the primary remote control device and adapted to communicate the control signal to the primary remote control device, thereby activating the primary remote control device for operation of the apparatus.

In accordance with a third broad aspect of the present invention, there is provided a method for controlling a primary remote control device, the method comprising: receiving a control signal for the remote operation of an apparatus from a secondary remote control device; processing the control signal by translating it into a trigger signal that may be recognized by the primary remote control device; and activating the primary remote control device using the trigger signal to thereby operate the apparatus.

The term “remote control” is understood to mean the device including all of its components, such as a transmitter, an antenna (for a wireless transmission), and the circuitry used to identify commands initiated by pressing a switch on the device.

It should be understood that the term “primary remote control” refers to an existing remote control, while the term “secondary remote control” refers to another device used to control the existing device.

### BRIEF DESCRIPTION OF THE DRAWINGS

Further features and advantages of the present invention will become apparent from the following detailed description, taken in combination with the appended drawings, in which:

FIG. 1a illustrates an embodiment for the device of the present invention;

FIG. 1b illustrates an embodiment for an antenna to be used with the device of FIG. 1a;

FIG. 1c illustrates an embodiment for a wire harness to connect the device of FIG. 1a and the antenna of FIG. 1b;

FIG. 1d illustrates an embodiment for an antenna to be used with the device of FIG. 1a;

FIG. 2 illustrates an embodiment of the system used to control a primary remote control;

FIG. 3 is a flowchart illustrating an embodiment of a method to control a primary remote control using a secondary remote control.

It will be noted that throughout the appended drawings, like features are identified by like reference numerals.

### DETAILED DESCRIPTION OF THE PREFERRED EMBODIMENT

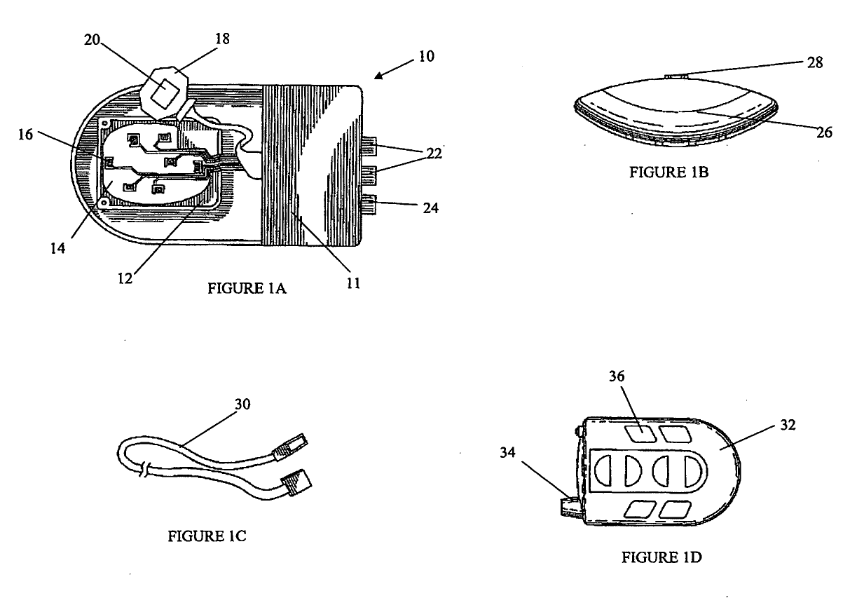

Now referring to FIG. 1a, there is shown an embodiment for a device 10 for controlling a primary remote control. The primary remote control may be any wireless remote control. For instance, it may be an infrared-based remote control, an RF-based remote control or the like. Alternatively, the primary remote control 20 is a wire-based remote control.

A housing unit 11 hosts control circuitry (not shown in FIG. 1a). The control circuitry is configured to be operatively connected to the primary remote control. The control circuitry has an interface such that it can be connected to the primary remote control. The interface may be a template specifically configured to interact with a given model of the primary remote control.

In the embodiment illustrated in FIG. 1a, the interface is a printed circuit board 14 having contacts 16 that activate the switches on the copper layer of a printed circuit board (PCB) of the primary remote control. The template has its contacts 16 positioned such that they are aligned with the switches of the primary remote control. In this embodiment, the housing of the primary remote control is opened and the PCB therein is removed. This PCB is placed inside the housing 11 of the device 10. A recess 12 is provided to receive the PCB and a connection is made between the PCB (which is essentially the primary remote control) and the control circuitry of the device 10. In this embodiment, no modifications are made to the primary remote control in order to have the secondary remote control be able to control it.

In an alternative embodiment, the housing of the primary remote control is not opened and the connection is made with the primary remote control intact. For example, if the primary remote control is infrared-based, then the connection to the control circuitry may be made using infrared signals. Any type of wired or wireless connection may be made to interface the primary remote control with the control circuitry of the device 10.

In the embodiment illustrated in FIG. 1a, a power source 20 is provided in the housing unit 11 for powering the primary remote control. The battery 20 resides on a surface 18 that may be inserted into the primary remote control in replacement of its original battery. Alternatively, the original primary remote control battery may be kept and used as is.

In one embodiment, the device has a pair of terminals 22 such that it may be connected to an antenna device 26. An embodiment for the antenna device 26 is illustrated in FIG. 1b. A terminal 28 is provided to physically link the housing unit 11 to the antenna device 26. An embodiment for a connecting wire 30 to link the antenna 26 to the housing unit is illustrated in FIG. 1c. Alternatively, the antenna 26 may be mounted to the housing unit 11 and integrated with the device 10. A receiver coupled between the antenna and the control circuitry may be provided internally to the device 10, internally to the antenna device 26, or externally to the system. When provided externally, the wire harness used for the antenna may instead be used for the receiver, the antenna and receiver being connected together.

Also illustrated in the embodiment of FIG. 1a is a terminal 24 for powering the device 10 using an external battery source, such as a car battery or any other type of battery. Alternatively, the device 10 may be powered with an internal power source.

FIG. 1d illustrates an embodiment for a secondary remote control. Any commercially available remote control is suitable. The secondary remote control 36, which may be a remote car starter, a television remote control, a garage door remote control, or other similar type of device, has an antenna 34 for sending a control signal wirelessly. The control signal is indicative of at least one key 36 pressed on the secondary remote control 32 by a user. A transmitter is provided inside the secondary remote control 32 to transmit the signal via the antenna 34.

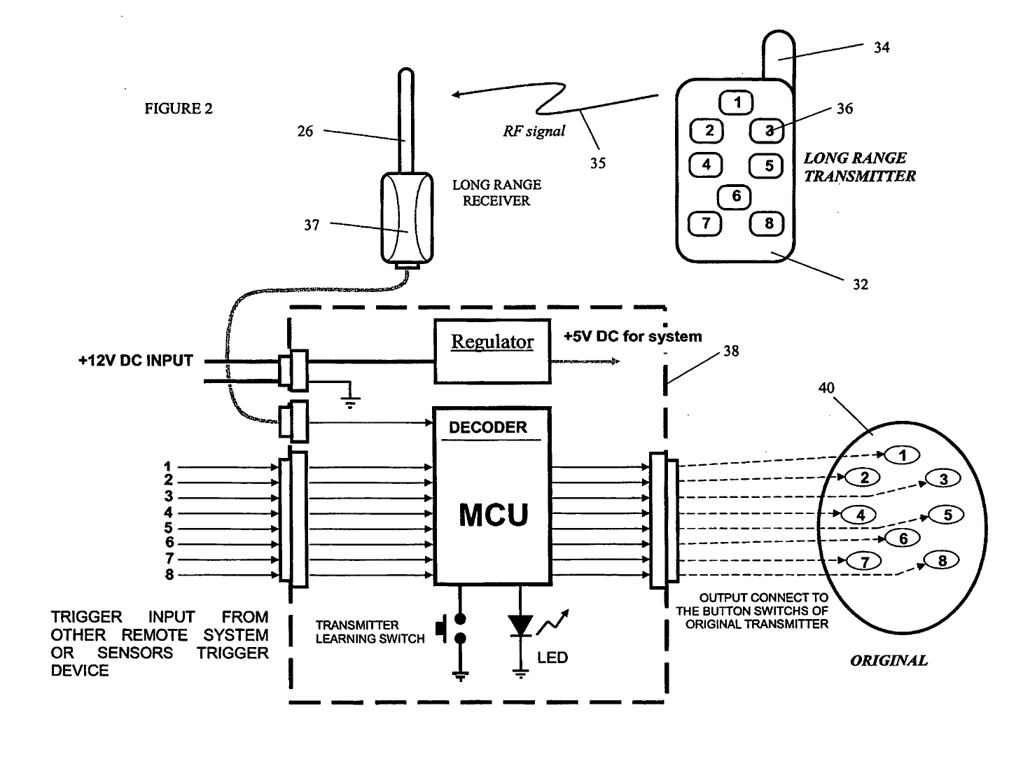

FIG. 2 is a block diagram showing an embodiment of the system of the present invention. The secondary remote control 32 is activated via one of its switches 36 and a control signal 35 is transmitted wirelessly by the antenna 34. Another antenna 26 receives the control signal 35, which in this embodiment is an RF signal, and a receiver 37 communicates it to the control circuitry 38 of the device 10. The control circuitry 38 translates the control signal 35 into a trigger signal that can be recognized by the primary remote control 40 and is used to activate the switches of the primary remote control 40 to thereby control an apparatus remotely.

It will be appreciated that the receiver 37 may operate according to various frequencies. In one embodiment, the receiver operates at a frequency of 339.41 MHz. The trigger signal may be provided to the primary remote control 40 according to various embodiments. In one embodiment, the trigger signal is provided to the primary remote control 40 using a wired connection. In another embodiment, the trigger signal is provided wirelessly. The wireless communication may be infrared, RF, or other known transmission types.

In one embodiment, the control circuitry 38 comprises a parallel port for performing a wire connection to the primary remote control 40. Alternatively, the interface is a PCB, which may be clear and flexible, as illustrated in FIG. 1a. In one embodiment, the control circuitry 38 is selected from a group consisting of FPGA, PIC, DSP or the like. In the embodiment illustrated in FIG. 2, the control circuitry 38 includes a Micro Controller Unit (MCU).

In the embodiment illustrated in FIG. 2, the receiver 37 is a long range receiver and the secondary remote control comprises a long range transmitter. The range of operation of the primary remote control is thereby extended.

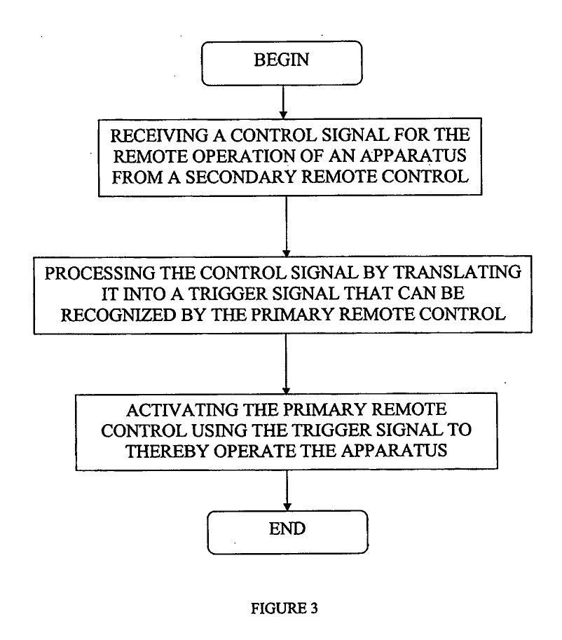

Now referring to FIG. 3, there is shown how the primary remote control may be controlled according to one embodiment of the method. A control signal is received for the remote operation of an apparatus from a secondary remote control. The control signal is then processed by translating it into a trigger signal that may be recognized by the primary remote control. The primary remote control is activated using the trigger signal and the apparatus is operated as if the primary remote control were being controlled by a user.

In one embodiment of the method, a printed circuit board of the primary remote control is interfaced with in order to activate the primary remote control. This interfacing may be done using a second printed circuit board aligned with the printed circuit board of the primary remote control to activate switches via a copper layer. Alternatively, other interfacing means may be used to activate the primary remote control.

In accordance with one embodiment of the method, identification codes to be received by the secondary remote control may be taught to the device via a “learning mode”. When in learning mode, the control circuitry records codes and identifies actions associated with each code. When in a signal receiving mode, the control circuitry receives a control signal, processes it, and generates a trigger signal to activate the primary remote control.

The embodiments of the invention described above are intended to be exemplary only. The scope of the invention is therefore intended to be limited solely by the scope of the appended claims.

I claim:

1. A system for controlling a primary remote control device, the system comprising:
a secondary remote control device having a transmitter and configured to transmit a control signal for remotely operating an apparatus;
a receiver adapted to receive said control signal;
an antenna for coupling said transmitter and said receiver; and
control circuitry coupled to said receiver and configured to be operatively connected to said primary remote control device, said control circuitry adapted to communicate said control signal to said primary remote control device, thereby activating said primary remote control device for operation of said apparatus.

2. A system as claimed in claim 1, wherein said control circuitry comprises an interface that interacts with a printed circuit board of said primary remote control device.

3. A system as claimed in claim 2, wherein said interface is a template specifically configured for interacting with a given model of said primary remote control device.

4. A system as claimed in claim 2, wherein said interface is a second printed circuit board that is aligned with said printed circuit board of said primary remote control device.

5. A system as claimed in claim 1, further comprising a housing unit for said receiver, said control circuitry and said primary remote control device.

6. A system as claimed in claim 5, wherein said housing unit has a terminal for powering said control circuitry using an external battery.

7. A system as claimed in claim 5, wherein said housing unit has a terminal for connecting to said antenna.

8. A system as claimed in claim 1, wherein said secondary remote control device has an operating range longer than that of said primary remote control device.

9. A device for controlling a primary remote control device, the apparatus comprising:
a receiver adapted to receive a control signal for remotely operating an apparatus from a secondary remote control device; and
control circuitry coupled to said receiver, configured to be operatively connected to said primary remote control device and adapted to communicate said control signal to said primary remote control device, thereby activating said primary remote control device for operation of said apparatus.

10. A device as claimed in claim 9, wherein said control circuitry comprises an interface that interacts with a printed circuit board of said primary remote control device.

11. A device as claimed in claim 10, wherein said interface is a template specifically configured for interacting with a given model of said primary remote control device.

12. A device as claimed in claim 10, wherein said interface is a second printed circuit board that is aligned with said printed circuit board of said primary remote control device.

13. A device as claimed in claim 9, further comprising a power source for powering said primary remote control device.

14. A device as claimed in claim 9, wherein said receiver is a long-range receiver.

15. A device as claimed in claim 9, further comprising a housing having a recess to hold said primary remote control device, said housing also comprising said control circuitry.

16. A device as claimed in claim 9, wherein said control circuitry is coupled to said receiver via a serial port.

17. A device as claimed in claim 9, wherein said control circuitry has a parallel port to connect to said primary remote control device and control a button switching thereof.

18. A device as claimed in claim 9, wherein said control circuitry comprises a learning mode to learn identification codes received from said secondary remote control device.

19. A device as claimed in claim 9, wherein said control circuitry has a parallel port input for external trigger input.

20. A method for controlling a primary remote control device, the method comprising:
receiving a control signal for the remote operation of an apparatus from a secondary remote control device;
processing the control signal by translating it into a trigger signal that may be recognized by said primary remote control device; and
activating said primary remote control device using said trigger signal to thereby operate said apparatus.

21. A method as claimed in claim 20, wherein said activating comprises interfacing with a printed circuit board of said primary remote control device.

22. A method as claimed in claim 21, wherein said interfacing comprises using a second printed circuit board aligned with said printed circuit board of said primary remote control device to activate switches via a copper layer.

23. A method as claimed in claim 20, further comprising learning identification codes in order to identify an operation associated with a given control signal.

24. A method as claimed in claim 20, wherein said processing comprises using a microcontroller unit.

25. A method as claimed in claim 20, wherein said receiving comprises using a long-range receiver.
